(19) United States
(12) Patent Application Publication
(10) Pub. No.: US 2002/0194518 A1
(43) Pub. Date: Dec. 19, 2002

(54) Apparatus and method for generating a skip signal

(76) Inventors: Kun-Yung Ken Chang, Los Altos, CA (US); Donald C. Stark, Los Altos Hills, CA (US)

Correspondence Address: LEE & HAYES, PLLC, 421 W. RIVERSIDE AVE, STE 500, SPOKANE, WA, 99201, US

(21) Appl. No.: 09/876,183

(22) Filed: Jun. 6, 2001

(51) Int. Cl. G06F 1/04; G06F 1/06

(52) U.S. Cl. 713/500

(57) ABSTRACT

A clock generator generates a first clock signal and a second clock signal such that the timing of the first and second clock signals is adjustable. A phase detector is coupled to receive the first and second clock signals and generate a skip signal by integrating the first clock signal over one half of a clock cycle. The skip signal indicates whether the first clock signal is ahead of the second clock signal. The first and second clock signals are calibrated individually. The skip signal generated by the phase detector indicates whether a load pulse should be sampled.

### RELATED APPLICATION

This application is related to a copending application Ser. No. 09/169,372, entitled “Method and Apparatus for Fail-Safe Resynchronization with Minimum Latency”, filed on Oct. 9, 1998, the disclosure of which is incorporated by reference herein.

### TECHNICAL FIELD

The present invention relates to clock circuitry and, more particularly, to methods and circuits that generate a skip signal using clocks with adjustable timing relationships to one another.

### BACKGROUND

Clock signals are used in electrical circuits to control the flow of data on data communication busses and control the timing and processing of various functions. In particular systems, data is written to a data bus or read from the data bus based on the state of one or more clock signals. These clock signals are necessary to prevent “collision” of data, i.e., the simultaneous transmission of data by two different devices on the same data bus. The clock signals also ensure that the desired data is available on the data bus when read by a device.

To transmit data on a bus at high speed and with low latency, a synchronous transmission system is often used. FIG. 1 illustrates a particular example of a data storage system 100 that utilizes a synchronous transmission system. A memory controller 102 controls the writing and reading of data to and from one or more memory storage modules 104, 106, and 108. Memory storage modules 104, 106, and 108 may contain any number of memory storage devices, such as random access memories (RAMs). The memory controller 102 and memory storage modules 104-108 are coupled to a data bus 110 and a clock signal transmitted on a pair of lines 112a and 112b. The clock signal may be single-ended or differential. The data bus 110 communicates data between the memory storage modules 104-108 and the memory controller 102. Lines 112a and 112b transmit a clock signal generated by a clock generator 120, coupled to line 112a. Line 112a is “looped back” to line 112b as it passes through memory controller 102. The clock signal carried by line 112a may be referred to as CTM (clock to master or clock to memory controller) and the clock signal carried by line 112b may be referred to as CFM (clock from master or clock from memory controller). Line 112b and each of the lines in data bus 110 are terminated through a resistor 114, which is coupled to Vcc.

The CTM clock signal is sent along with the data signal along bus 110 until it reaches the appropriate memory device, where the clock signal is used to clock the data. By sending the clock signal along with the data signal, the propagation delay of the two signals is matched.

The CTM and CFM clock signals have the same frequency, but have an arbitrary phase relationship. The phase relationship between the two clock signals depends on the physical location of the memory storage module relative to the memory controller. The uncertain phase relationship between the two clock signals creates a non-deterministic setup and hold window for the data from the receive clock domain into the transmit clock domain, which may result in synchronization failures.

An existing skip circuit monitors the timing relationship between the CTM and CFM clocks and determines whether a load pulse signal, which loads the data from the receive clock domain into the transmit clock domain and is generated in the receive clock domain, should be sampled on the rising edge or the falling edge of a quadrature CTM clock. This existing skip circuit works with systems in which the transmit and receive clocks are fixed (i.e., not adjustable). Such a skip circuit is described in copending application Ser. No. 09/169,372, incorporated by reference above.

The phase difference between the two clocks can be viewed as a fraction of the clock cycle time. This phase difference is defined as t_{TR}. With two clocks of cycle time t_{CYCLE} and with clock phase relative to the source defined as t_{TXCLK} for the transmit clock and t_{RCLK} for the receive clock, t_{TR} is the relative phase between the falling edges of the clocks as a fraction of the clock cycle time. t_{TR} is represented as:

$${t}_{TR} = \frac{{t}_{RCLK} - {t}_{TXCLK}}{{t}_{CYCLE}}$$

Using the above equation, the phase position of two clocks with the same relationship would be t_{TR}=0, and two clocks that are inverted from one another would be t_{TR}=0.5 (i.e., a phase difference of 50%).

FIG. 2 is a timing diagram illustrating the CTM clock, the phase difference between the CTM and CFM clocks (i.e., t_{TR}), and the resulting skip signal. As shown in FIG. 2, when t_{TR} is in the range of 0 to 0.5, the skip signal value is zero, indicating that the load pulse should be sampled on the rising edge of the CTM clock. When t_{TR} is in the range of 0.5 to 1.0, the skip signal value is one, indicating that the load pulse should be sampled on the falling edge of the CTM clock.

The system discussed above utilizes transmit and receive clocks that have fixed timing relationships to one another. Other systems provide adjustable transmit and receive clocks that can be calibrated such that the data can be sampled in the middle of a data window, thereby maximizing the setup and hold window of the receivers. This configuration improves the timing margin of the system. However, the use of calibrated clocks may cause the timing relationship between the transmit clock and the receive clock to deviate from the timing relationship between the CTM and CFM clocks. Thus, the CTM and CFM clocks cannot be used to accurately determine the value of the skip signal in this type of system.

An improved architecture described herein addresses these and other problems by generating a skip signal using clocks that have adjustable timing relationships to one another.

### SUMMARY

The improved architecture discussed below generates a skip signal using two clock signals that are individually adjustable. The architecture also maintains backward compatibility with previous architectures that generated a skip signal on the cycle boundary between the CTM clock and the CFM clock.

In one embodiment, a clock generator generates a first clock signal and a second clock signal such that the timing relationship between the first and second clock signals is arbitrary. Further, the first and second clock signals are individually adjustable. A phase detector is coupled to receive the first and second clock signals and generate a skip signal by integrating the first clock signal. The skip signal indicates whether the first clock is ahead of the second clock.

In another embodiment, the phase detector generates a skip signal by integrating the first clock signal over one half of a clock cycle.

In an alternate embodiment, the first and second clock signals are calibrated individually.

In a described implementation, the skip signal indicates whether a load pulse should be sampled.

In a particular implementation, the skip signal has a first value if the first clock is ahead of the second clock, and the skip signal has a second value if the second clock is ahead of the first clock.

### BRIEF DESCRIPTION OF THE DRAWINGS

FIG. 1 illustrates a particular example of a data storage system.

FIG. 2 is a timing diagram illustrating the CTM clock, the phase difference between the CTM and CFM clocks (i.e., t_{TR}), and the resulting skip signal.

FIG. 3 is a timing diagram illustrating the timing of various signals in an architecture in which the clock signals are calibrated.

FIG. 4 illustrates a circuit capable of generating a skip signal based on two calibrated clock signals.

FIG. 5 is a timing diagram illustrating the relationship between the TCLK and the RCLK signals.

FIG. 6 is a flow diagram illustrating a procedure for generating a skip signal using a pair of calibrated clock signals.

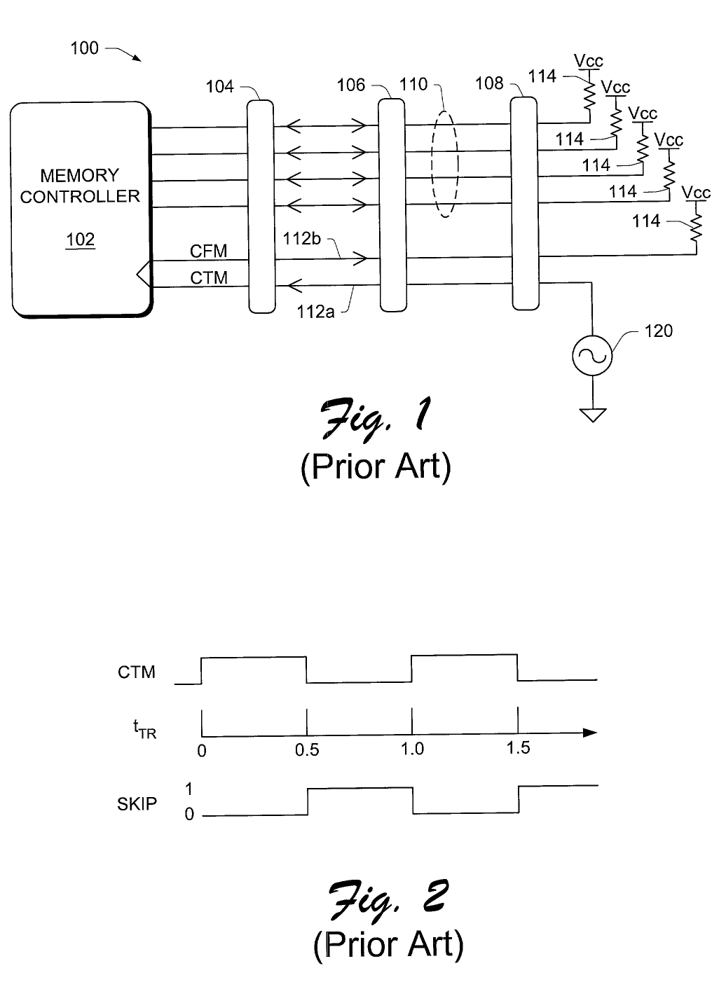

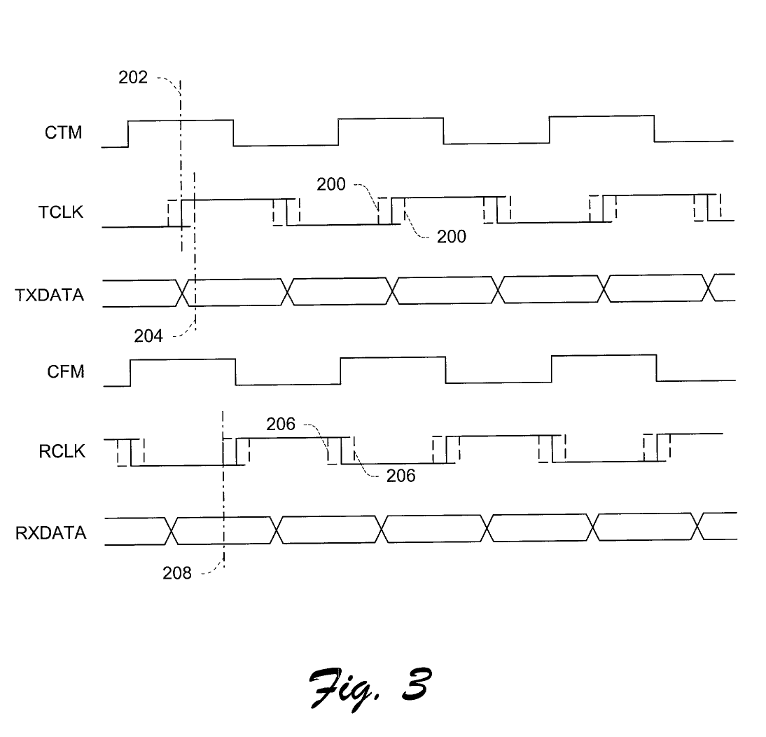

### DETAILED DESCRIPTION

An improved architecture is discussed herein for generating a skip signal using clocks that have adjustable timing relationships to one another. In particular, the timing of the transmit and the receive clocks are adjustable with respect to each other. This adjustment allows the transmit and receive clocks to be calibrated such that the data can be sampled in the middle of a data window, thereby maximizing the setup and hold window of the receivers. This use of calibrated clocks may cause the timing relationship between the transmit and receive clocks (TCLK and RCLK) to deviate from the timing relationship between the CTM and CFM clocks. Thus, the CTM and CFM clocks cannot be used to generate the skip signal in an architecture having calibrated transmit and receive clocks.

The architecture described herein uses the calibrated transmit and receive clocks to determine the skip signal value. This architecture also maintains backward compatibility for systems that generate the skip circuit signal on the cycle boundaries between the CTM and CFM clocks. Throughout the description of the architecture, the terms “calibrated clocks” and “adjustable clocks” have the same meaning; i.e., two clocks that can have their timing adjusted with respect to one another to produce the desired calibration. Each of the two clocks can be adjusted (or calibrated) individually.

FIG. 3 is a timing diagram illustrating the timing of various signals in an architecture in which the clock signals are calibrated. Specifically, FIG. 3 shows the timing relationship between CTM and the transmit clock (TCLK) and shows the timing relationship between CFM and the receive clock (RCLK). Prior to calibration, TCLK is 90 degrees behind CTM and RCLK is 180 degrees behind CFM, as illustrated by the solid lines for TCLK and RCLK. Broken lines 200 associated with TCLK represent the effects of calibration. As shown, the TCLK signal can be adjusted forward or backward with respect to CTM to establish the desired calibration. Similarly, broken lines 206 associated with RCLK represent the effects of calibration. As with TCLK, the RCLK signal can be adjusted forward or backward with respect to CFM to produce the desired calibration. The TCLK and RCLK signals can be adjusted (or calibrated) independently of one another.

A dual-loop delay-locked loop (DLL) circuit on, for example, a memory device provides for the adjustment of TCLK and RCLK. The dual-loop DLL includes digitally-controlled mixers such that each mixer can provide a clock signal which can be adjusted up to 360 degrees. Separate mixers are provided for TCLK and RCLK. The control settings for the clock signal adjustment can be handled on the memory device or on the memory controller. In a particular implementation, the control settings for the clock signal adjustment is handled on the memory controller to allow interaction with testing procedures performed by the memory controller.

A broken line 202 associated with TCLK and CTM indicates that the unadjusted TCLK signal is 90 degrees out of phase with CTM. Another broken line 204 associated with TCLK and TXDATA indicates that the adjusted TCLK signal is aligned with the beginning of a corresponding TXDATA window. As shown in FIG. 3, each rising edge and each falling edge of the adjusted TCLK signal is aligned with the beginning of a particular TXDATA window. Thus, TCLK is adjusted such that it is synchronized with TXDATA.

A broken line 208 associated with RCLK and RXDATA indicates that the adjusted RCLK signal is centered on a corresponding RXDATA window. As shown, each rising edge and each falling edge of the adjusted RCLK signal is centered on a particular RXDATA window.

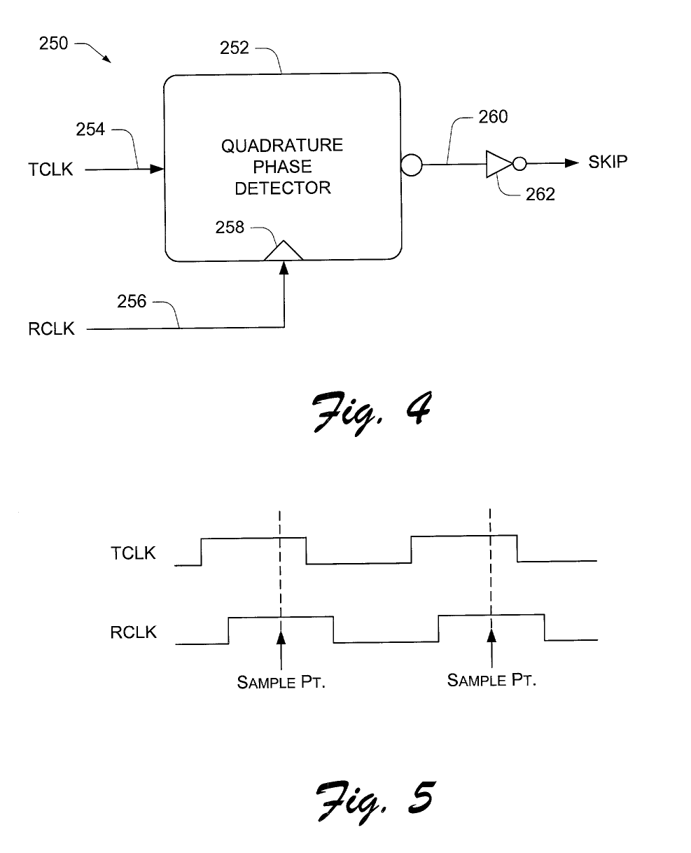

FIG. 4 illustrates a circuit 250 capable of generating a skip signal based on two calibrated clock signals. Additionally, the circuit 250 is capable of generating a skip signal based on two clock signals having a fixed phase relationship, thereby providing backward compatibility for architectures utilizing clock signals with a fixed phase relationship. A particular implementation uses TCLK and RCLK to determine the skip signal value. In this implementation, either TCLK or RCLK is shifted by 90 degrees.

Circuit 250 in FIG. 4 includes a quadrature phase detector 252 coupled to receive a TCLK signal on an input 254 and coupled to receive a RCLK signal on an input 256. Input 256 is a clock input, identified by the clock input symbol 258. Quadrature phase detector 252 generates an inverted skip signal on output 260. An inverter 262 is coupled to output 260 to produce a non-inverted skip signal. The skip signal identifies when the load pulse should be sampled. Depending on the skip signal desired (i.e., the requirements of the circuit or device receiving the skip signal), alternate embodiments may delete inverter 262 from FIG. 4.

The output of quadrature phase detector 252 is based on which clock signal (i.e., TCLK or RCLK) is ahead of the other clock. For example, if TCLK is ahead of RCLK (at the sample point), then the inverted output of quadrature phase detector 252 is high (i.e., a logic ‘1’). If RLCK is ahead of TCLK (at the sample point), then the inverted output of quadrature phase detector 252 is low (i.e., a logic ‘0’). Thus, instead of using external clocks to generate a SKIP signal, the system generates a SKIP signal using the adjusted clocks TCLK and RCLK.

In one embodiment, the quadrature phase detector 252 in FIG. 4 is implemented using an integrator which integrates the data waveform over half a clock cycle. This integration is performed instead of sampling the data at the rising edge of the clock (i.e., the rising edge of TCLK). Integrating the data waveform over half a clock cycle is substantially equivalent to sampling the data 90 degrees later than the rising edge of the clock. Thus, the integration operation accomplishes the 90 degree phase shift of the clock for backward compatibility with non-adjustable clock signals. In this embodiment, RCLK is used to integrate TCLK using the quadrature phase detector 252.

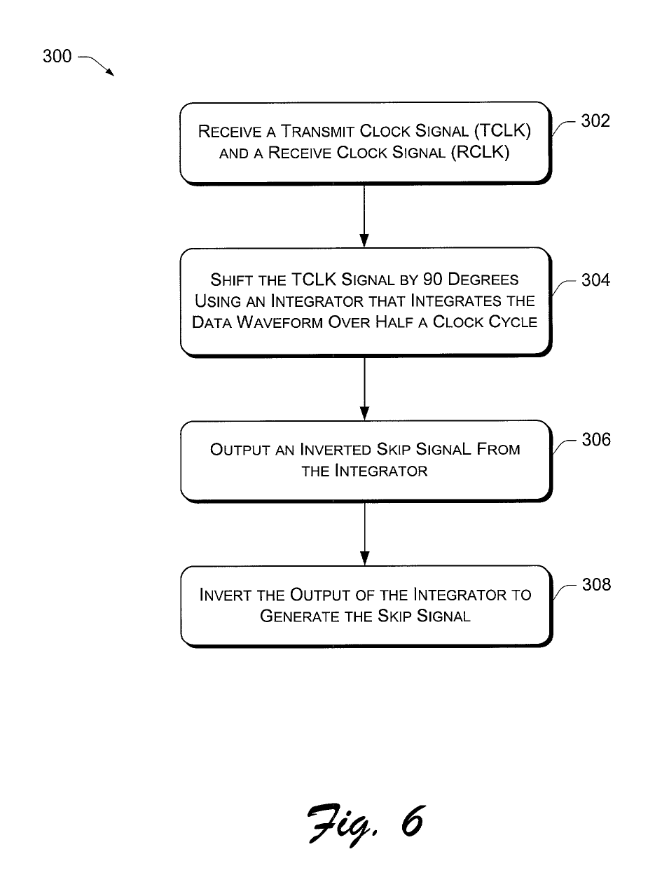

FIG. 5 is a timing diagram illustrating the relationship between the TCLK and the RCLK signals. The data sampling point is shown as the middle of each positive half cycle of the RCLK signal. As shown in FIG. 5, the RCLK signal is slightly behind the TCLK signal (i.e., TCLK is ahead of RCLK). Thus, the inverted output of the quadrature phase detector 252 (FIG. 4) is high (a logic ‘1’), and the resulting SKIP signal is low (a logic ‘0’).

FIG. 6 is a flow diagram illustrating a procedure 300 for generating a skip signal using a pair of calibrated clock signals. Initially, the procedure 300 receives a transmit clock signal TCLK and a receive clock signal RCLK (block 302). The TCLK signal is shifted by 90 degrees using an integrator that integrates the data waveform (i.e., the TCLK signal) over half of a clock cycle (block 304). After integrating the data waveform, the integrator outputs an inverted skip signal (block 306). Finally, the procedure 300 inverts the output of the integrator to generate the skip signal (block 308). As mentioned above, alternate embodiments may not require the inversion of the skip signal. In such embodiments, block 308 of FIG. 6 is not required.

Thus, a system has been described that generates a skip signal based on a pair of adjustable clocks that can be calibrated such that the data can be sampled in the middle of a data window. Furthermore, the described system provides backward compatibility that allows for the generation of a skip signal if the pair of clocks are not adjustable (i.e., the clocks have fixed timing with respect to each other).

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. An apparatus comprising:
a clock generator configured to generate a first clock signal and a second clock signal, wherein the timing relationship between the first and second clock signals is arbitrary and wherein the first and second clock signals are individually adjustable; and
a phase detector coupled to receive the first and second clock signals, the phase detector generating a skip signal by integrating the first clock signal, wherein the skip signal indicates whether the first clock signal is ahead of the second clock signal.

2. An apparatus as recited in claim 1 wherein the value of the skip signal is based on the phase difference between the first clock signal and the second clock signal.

3. An apparatus as recited in claim 1 wherein the skip signal has a first value if the first clock signal is ahead of the second clock signal and the skip signal has a second value if the second clock signal is ahead of the first clock signal.

4. An apparatus as recited in claim 1 wherein the phase detector generates a skip signal by integrating the first clock signal over one half of a clock cycle.

5. An apparatus as recited in claim 1 further including an inverter coupled to an output of the phase detector.

6. An apparatus as recited in claim 1 wherein the phase detector is a quadrature phase detector.

7. An apparatus as recited in claim 1 wherein the first and second clock signals are calibrated individually.

8. An apparatus as recited in claim 1 wherein the skip signal indicates whether a load pulse should be sampled.

9. A method comprising:
receiving a first clock signal and a second clock signal;
shifting the phase of the first clock signal by 90 degrees using a quadrature phase detector; and
generating a skip signal indicating whether a load pulse should be sampled, wherein the value of the skip signal is based on the phase difference between the first clock and the second clock.

10. A method as recited in claim 9 wherein the skip signal has a first value if the first clock signal is ahead of the second clock signal and the skip signal has a second value if the second clock signal is ahead of the first clock signal.

11. A method as recited in claim 9 wherein the shifting the phase of the first clock by 90 degrees includes integrating the first clock signal.

12. A method as recited in claim 9 wherein the shifting the phase of the first clock by 90 degrees includes integrating the first clock signal over one half of a clock cycle.

13. A method as recited in claim 9 wherein the first and second clock signals are individually adjustable.

14. A memory system comprising:
a memory storage device;
a data bus coupled to the memory storage device;
a clock generator configured to generate a first clock signal and a second clock signal, wherein the timing relationship between the first and second clock signals is arbitrary; and
a memory controller coupled to the data bus, the memory controller including a phase detector coupled to receive the first and second clock signals, the phase detector generating a skip signal based on the phase difference between the first clock signal and the second clock signal.

15. A memory system as recited in claim 14 wherein the phase detector generates a skip signal by integrating the first clock signal over one half of a clock cycle.

16. A memory system as recited in claim 14 wherein the first and second clocks are individually adjustable.

17. A memory system as recited in claim 14 wherein the phase detector is a quadrature phase detector.

18. A memory system as recited in claim 14 wherein the first and second clock signals are calibrated individually.

19. A memory system as recited in claim 14 wherein the skip signal indicates whether the load pulse should be sampled.

20. A memory system as recited in claim 14 wherein the skip signal has a first value if the first clock signal is ahead of the second clock signal, and the skip signal has a second value if the second clock signal is ahead of the first clock signal.
